(19) United States
(12) Patent Application Publication
(10) Pub. No.: US 2012/0063723 A1
(43) Pub. Date: Mar. 15, 2012

(54) OPTICAL FIBRE CONNECTOR

(75) Inventors: Peter David Jenkins, Woodbridge (GB); Kim Samuel Howard Leeson, Ipswich (GB)

(73) Assignee: MINIFLEX LIMITED, Woodbridge (GB)

(21) Appl. No.: 13/229,267

(22) Filed: Sep. 9, 2011

(30) Foreign Application Priority Data
Sep. 10, 2010 (GB) 1015120.7

(51) Int. Cl. G02B 6/36

(52) U.S. Cl. 385/78

(57) ABSTRACT

The present invention provides an optical fibre connector (1) having a fibre connector sub-assembly (21) and an outer connection sleeve (40), sub-assembly (21) having an optical fibre and an inner housing (20). The optical fibre is held within housing (20) along axis (5), and is terminated for optical connection to a mating connector along a connection direction (61). Sleeve (40) has a securing portion (50) and a connecting portion (48). Securing portion (50) is fixed to sub-assembly (21) so that sleeve (40) extends around sub-assembly (21). Connecting portion (48) has an inner surface that provides a socket (44) for receiving a corresponding portion of a mating connector along direction (61). Socket (44)'s inner surface has at least one rib that extends transverse to direction (61), connecting portion (48) being elastic such that the rib(s) may, in use, stretch over and engage with a corresponding feature of a mating connector.

### RELATED APPLICATION

This application claims the benefit of and priority to United Kingdom Application No. 1015120.7, filed Sep. 10, 2010.

### BACKGROUND

a. Field of the Invention

The present invention relates to an optical fibre connector, and in particular to a water resistant optical fibre connector.

b. Related Art

There are many different types of optical fibre connector, but a particularly common type is the “Subscriber Connector”, or SC connector, originally developed by NTT (Reg. TM). SC connectors have convenient push/pull style mating, and are approximately square in cross-section and with a 2.5 mm diameter ferule at the termination of the optical fibre, surrounded by a plastic housing for protection. SC connectors are available in single or duplex configurations. The SC connector latches into a matching socket in a simple push motion. The socket may be provided on a bulkhead, for example as part of a so-called unitor which has a similar socket on an opposite side of the bulkhead for connection to another SC connector. The unitor sometimes includes a fibre stub inside a fixed ferrule, particularly if a filter or an attenuator is included in the optical path.

The push-pull design includes a spring against which the ferrule slides within a plastic inner housing. This arrangement provides a reliable contact pressure at the ferrule end and resists fibre end face contact damage of the optical fibre during connection. The connector can be quickly disconnected by first pulling back an outer housing, which is slidable relative to the inner housing, to disengage a latch between the socket and the inner housing, before pulling the optical fibre connector from the socket. Until the latch is thus disengaged, the latch prevents withdrawal of the connector when the optical fibre cable is pulled in a direction away from the socket.

An example of such as SC connector is disclosed in patent document WO 2008/135727 A.

In recent years there has been an increasing need to improve data bandwidth to businesses and homes. It has therefore become common to run optical fibre cables either into the home or business or to an above ground cabinet or in-ground junction box near the end user. As the connection locations are exposed to the weather, it may not always be possible to ensure that such connections are protected from water ingress or other environmental contaminants.

While prior art SC connectors such as that described in WO 2008/135727 A are very effective in many situations, such a connector is not water resistant and can be affected by other forms of environmental contamination.

Water resistant SC connectors have therefore been developed. One example is the DLX (Trade Mark) fibre optic connector system developed by ADC Telecommunications, Inc. This connector system protects an SC connector inside an in-line or bulkhead enclosure that surrounds and environmentally isolates the entire SC connector. The enclosure uses a coupling nut to join two parts of the enclosure together, with a water seal being ensured by an O-ring.

While such a system is effective in providing environmental protection to the connector, the provision of the enclosure adds to cost. This system also relies on the worker making the connection to correctly tighten the coupling nut after the optical connection has been made.

It is an object of the present invention to provide a more convenient water resistant optical fibre connector and optical fibre connector system.

### SUMMARY OF THE INVENTION

According to the invention, there is provided an optical fibre connector having a fibre connector sub-assembly and assembled about said sub-assembly an outer connection sleeve, said sub-assembly comprising an optical fibre and an inner housing, wherein:
the optical fibre is held within the inner housing along an optical axis, the optical fibre being terminated for optical connection to a mating connector along a connection direction;
the outer connection sleeve has a securing portion and a connecting portion, the securing portion being fixed to said sub-assembly so that the outer connection sleeve extends around said sub-assembly;
the connecting portion of said sleeve has an inner surface, the inner surface providing a socket for receiving a corresponding portion of said mating connector along said connection direction;
wherein said inner surface has at least one rib, said rib extending transverse to said connection direction, the connecting portion of said sleeve being elastic such that said at least one rib may, in use, stretch over and engage with a corresponding feature of said mating connector.

In a preferred embodiment of the invention, the fibre connector sub-assembly comprises a cylindrical ferrule, the optical fibre being held within the ferrule along an axis of the ferrule, the optical fibre being terminated at an end face of the ferrule for optical connection to the mating connector along the connection direction.

Preferably, the socket extends fully around the inner housing. The connecting portion may also have substantially cylindrical inner and outer surfaces.

By stretching the ribs over and engaging with corresponding features of a mating connector as the connectors are brought together and joined, it is possible both to hold the connectors together and maintain the optical connection and also to provide a water resistant seal around the fibre connector sub-assembly.

In a preferred embodiment of the invention, the socket has a substantially annular shape between the outer connection sleeve and the inner housing. The securing portion holds the inner housing within the connecting portion, with an inner surface of the connecting portion being spaced apart from an outer surface of the inner housing to form the socket.

At least one rib, and preferably a pair of ribs, project inwards from the inner surface of the connecting portion.

In a preferred embodiment of the invention, the ribs project inwards from an otherwise smooth internal surface of the connection sleeve. The ribs may, however, be bounded by at least one corresponding groove in the inner surface of the connecting portion.

It is particularly advantageous if the, or each, rib has an engagement surface for engaging with a corresponding feature of a mating connector, with the engagement surface then extending transverse to the connection direction.

To make to the connection more secure, it is preferred if there is a series of ribs spaced apart along the connection direction. The series of ribs most preferably has a generally square profile in cross-section along the connection direction, with this profile being asymmetric to facilitate engagement in connection direction and to hinder disengagement in the opposite direction with corresponding features of a mating connector.

In a preferred embodiment of the invention the entire outer connection sleeve is made as a unitary moulding from an elastomeric material, for example a natural or a synthetic rubber. It is, however, only necessary that the connecting portion be elastic, and so the connection sleeve may be made from more than one material, for example an elastomeric connecting portion, with the securing portion and any strain relief portion being made from a flexible, but substantially inelastic material.

The fibre connector sub-assembly may comprise spring biasing means, with the ferrule being relatively moveable with respect to the inner housing along the ferrule axis and being spring biased by the spring biasing means along the ferrule axis towards the ferrule end face.

The engagement of the outer connection sleeve with the corresponding feature of the mating connector can then serve, in use, to secure the fibre connector sub-assembly along the connection direction against a load from the spring biasing means resulting from engagement of the ferrule made in the optical connection with the mating connector.

Also according to the invention, there is provided an optical fibre connector system, comprising a first optical fibre connector and a second optical fibre connector, the first optical fibre connector having a fibre connector sub-assembly and assembled about said sub-assembly an outer connection sleeve, said sub-assembly comprising a first optical fibre, and an inner housing and the second optical fibre connector having a connection plug, wherein:
the first optical fibre is held within the inner housing along an optical axis, the first optical fibre being terminated for optical connection with the second optical fibre connector along a connection direction;
the outer connection sleeve has a securing portion and a connecting portion, the securing portion being fixed to said sub-assembly so that the outer connection sleeve extends around said sub-assembly;
the connecting portion of said sleeve has an inner surface, the inner surface providing a socket for receiving the connection plug of the second connector along said connection direction;
wherein said inner surface has at least one rib and the connection plug has at least one corresponding feature shaped to engage with said at least one rib, said rib extending transverse to said connection direction, the connecting portion of said sleeve being elastic such that said at least one rib may, in use, stretch over and engage with said at least one corresponding feature of the connection plug, said engagement serving in use to maintain said optical connection and provide a water resistant seal around the fibre connector sub-assembly.

In a preferred embodiment of the invention, the fibre connector sub-assembly comprises a first cylindrical ferrule, the optical fibre being held within the ferrule along an axis of the ferrule, the optical fibre being terminated at an end face of the ferrule for optical connection to the mating connector along the connection direction.

In a preferred embodiment of the invention, the second optical fibre connector comprises a second optical fibre, a second cylindrical ferrule, the first and second ferrules abutting each other when the optical connection is made between the first and second optical fibres.

The optical fibre connector system may comprise additionally spring biasing means for providing positive contact with the first cylindrical ferrule to maintain an optical connection. The engagement of the outer connection sleeve with the corresponding feature of the second optical fibre connector then serves to secure the fibre connector sub-assembly along the connection direction against a load from the spring biasing means resulting from engagement of the first ferrule made in the optical connection with the second optical fibre connector.

In a preferred embodiment of the invention, the second optical fibre connector comprises restraining means for securing the outer connection sleeve when the first and second connectors are engaged with each other. The restraining means serves to restrain the, or each, rib from stretching over and disengaging with the corresponding feature of the connection plug when the first and second connectors are pulled apart. The restraining means may be a substantially cylindrical sleeve affixed to the second optical fibre connector and extending around the connecting portion of the outer connection sleeve.

### BRIEF DESCRIPTION OF THE DRAWINGS

The invention will now be further described, by way of example only, and with reference to the accompanying drawings, in which:

FIG. 1 is an exploded perspective view of the components forming a ferrule holder sub-assembly to be housed within an inner housing to form a fibre connector sub-assembly, for use in an optical fibre connector, according to a first preferred embodiment of the invention;

FIG. 2 is a perspective view showing how an outer connection sleeve is connected over the inner housing of the fibre connector sub-assembly of FIG. 1;

FIG. 3 is a top plan view of the outer connection sleeve of FIG. 2;

FIG. 4 is an end view of the outer connection sleeve, showing how this has an opening for receiving the assembled fibre connector sub-assembly;

FIG. 5 is a cross-section view the outer connection sleeve taken along line V-V of FIG. 4;

FIG. 6 is a perspective view showing two of the assembled optical fibre connectors of FIG. 2 when connected either side of a bulkhead optical fibre unitor connector, to form an optical fibre connector system according to a second preferred embodiment of the invention;

FIG. 7 is a cross-section view along an optical axis of the optical fibre connector system of FIG. 6;

FIG. 8 is a perspective view showing two of the assembled optical fibre connectors of FIG. 2 when connected either side of a bulkhead optical fibre unitor connector, to form an optical fibre connector system according to a third preferred embodiment of the invention;

FIG. 9 is a cross-section view along an optical axis of the optical fibre connector system of FIG. 8;

FIG. 10 is a perspective view of the optical fibre unitor connector of FIGS. 6 to 9;

FIG. 11 is an end view of one end of the optical fibre unitor connector of FIG. 10; and

FIG. 12 is a cross-section view of the optical fibre unitor connector taken along lines XII-XII of FIG. 11.

### DETAILED DESCRIPTION

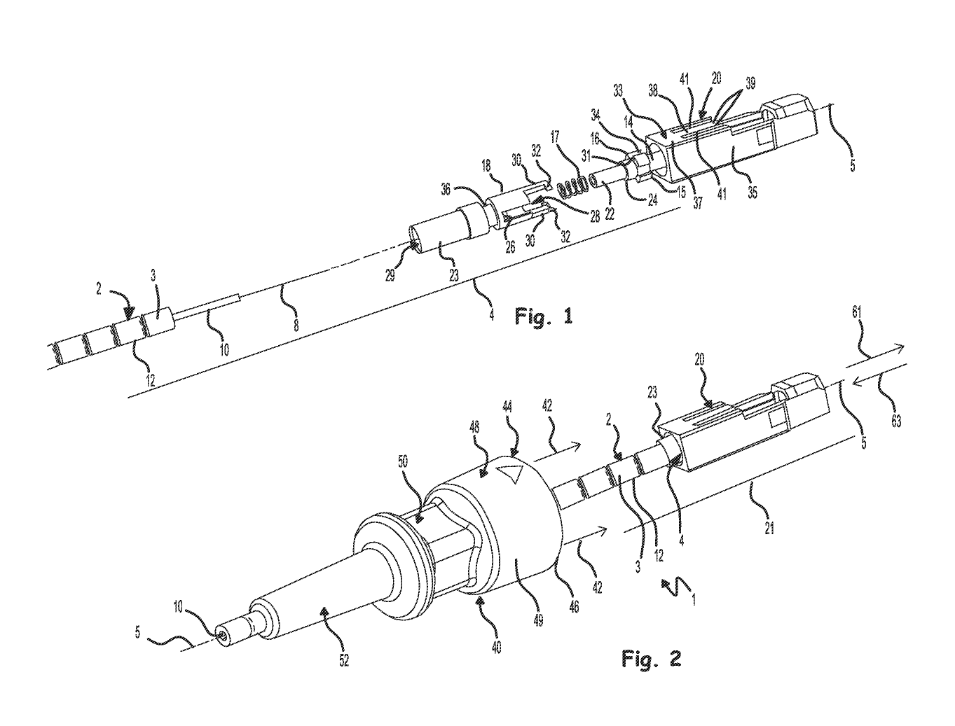

FIG. 1 shows an exploded view of the components forming a ferrule holder sub-assembly 4 for an optical fibre connector. The ferrule holder sub-assembly 4 is the same as that disclosed in WO 2008/135727 A. It should be noted that this particular form of ferrule holder sub-assembly is not the only type of sub-assembly suitable for the invention disclosed herein, and other known types of ferrule holder sub-assembly may equally well be used in its place. The prior art ferrule holder sub-assembly 4 described below is therefore given as one example only in order to aid better understanding of the invention as defined by the scope of the appended claims.

The ferrule holder sub-assembly 4 comprises an end portion 3 of an optical fibre cable 2. The cable 2 holds a single strand of 125 μm diameter single mode optical fibre 8, protected by primary and secondary buffering layers 10, about 900 μm in diameter and by an outer sheath 12, typically 3 mm to 5 mm in diameter. The optical fibre 8 is terminated at an end face of a cylindrical ceramic ferrule 14 in a manner well-known to those skilled in the art, and defines a ferrule axis 5 which extends centrally through the ferrule holder sub-assembly 4.

In addition to the cable 2 and ferrule 14, the ferrule holder sub-assembly 4 comprises a ferrule holder 16 in which the ferrule is seated, a helical spring 17 and a ferrule holder carrier 18. The ferrule holder 16 has a cylindrical stem 22 which extends in an axial direction away from the ferrule 14 towards a sleeve 23 of the ferrule holder carrier 18 which is used to make a crimp connection around the optical fibre cable sheathing 12. When assembled, the spring 17 is seated around the stem 22 between an annular shoulder 24 on the ferrule holder 16 and a similar annular surface 26 within a generally cylindrical recess 28 of the ferrule holder carrier 18. The stem 22 is then slidably seated in a closely fitting bore 29 of the ferrule holder carrier.

During assembly, the ferrule holder 16 and seated ferrule 14 are inserted axially into the recess 28 of the ferule holder carrier 18. The carrier 18 has a pair of arms 30 around a portion of the stem 22 nearest the ferrule 14 which extend axially forwards of the stem on opposite sides of a base 15 of the ferrule holder. Two pairs of curved fingers 32 are provided, each pair extending in opposite circumferential directions at the end of each carrier arm 30. The fingers 32 extend transversely to the length of the carrier arms 30 partially around the circumference of a portion of the ferrule nearest the base 15 of the ferrule holder. The ferrule base 15 has four cycles of crenellations 34 spaced symmetrically around the circumference of the base and which provide four corresponding channels 31 that extend parallel to the optical fibre axis 5. These crenellations 34 are in the form of alternating radially high and low cylindrically shaped regions which thereby define the channels 31 with the circumferential and axial extent of each of the high and low regions being the same. The arms 30 are seated in a pair of these channels 31 defined by opposite radially low regions in a sliding fit between adjacent high regions, and reach axially forwards of the ferrule base 15 and crenellations 34 so that the fingers 32 engage with the intervening radially high regions on a side of the base 15 opposite the annular shoulder 24 against which the spring 17 is engaged. This arrangement permits a degree axial movement of the ferrule holder 16, with movement being therefore limited in one direction by the compression of the spring 17 between the annular surface 24 of the ferrule holder carrier 18 and the similarly shaped annular shoulder 26 of the ferrule holder 16, and in the other axial direction by the contact of the fingers 32 with the radially high regions of the crenellations 34 on the base 15 of the ferrule holder 16. As can be seen from the drawings, the ferrule holder base 15 and ferrule holder carrier 18 also have a common cylindrical outer envelope.

The arrangement described above has the benefit of minimising the extent of the ferrule holder base 15 and ferrule holder carrier 18 in a radial direction which leaves more room outside the sub-assembly 4 for other components, as will be explained below.

The rotational orientation of the ferrule holder carrier 18 may be set at one of four orientations relative to the ferrule 14 in the ferrule holder 16 owing to the seating of the carrier arms 30 in the crenellations 34. In this way, a first rotational key is provided between the ferrule holder 16 and the ferrule holder carrier 18.

After the ferrule holder sub-assembly 4 has been assembled, an inner housing 20 is inserted in an axial direction over the projecting ferrule 14 and surrounding ferrule holder carrier 18 to form a fibre connector sub-assembly 21, as shown in FIG. 2. The ferrule holder carrier 18 has an annular groove 36 within the cylindrical envelope defined by the radially outermost surfaces of the ferrule holder carrier. The inner housing 20 is generally rectangular in a cross-section perpendicular to the connector axis 5 with an outer surface 33 having two pairs of opposite side walls 35, 37 (only one of each of which is visible in FIG. 1). Each of the two opposite side walls 37 has an arm 38, one of which is visible in FIG. 1, and each arm has at its end a radially inwardly projecting detent (not shown). The inner housing arms 38 have sides 39 each of which is bounded by a slot 41 that extends through each wall 37. The detents are initially deflected radially outwards and then snap into engagement with the groove 36 as the inner housing 20 is slid over the ferrule holder carrier 18. This engagement prevents relative axial movement of the inner housing 20 and the ferrule holder carrier 18 in one direction. The advantage of this arrangement is that the groove 36 provides an engagement feature for the inner housing which does not add to the radial dimensions of the ferrule holder sub-assembly 4, which keeps the ferrule holder sub-assembly radially compact 4, giving more latitude in the design of the surrounding inner housing 20. For example, this can permit the walls 35, 37 of the inner housing 20 to be thicker in order to make the inner housing larger and more robust.

Relative movement in the opposite direction is prevented by abutting of the annular surface 26 and an end surface of a rib (not shown) within the inner housing that engages as a rotational key with the two channels 31 not occupied by the carrier arms 30. In this way, a second rotational key is provided between the ferrule holder carrier 18 and the inner housing 20.

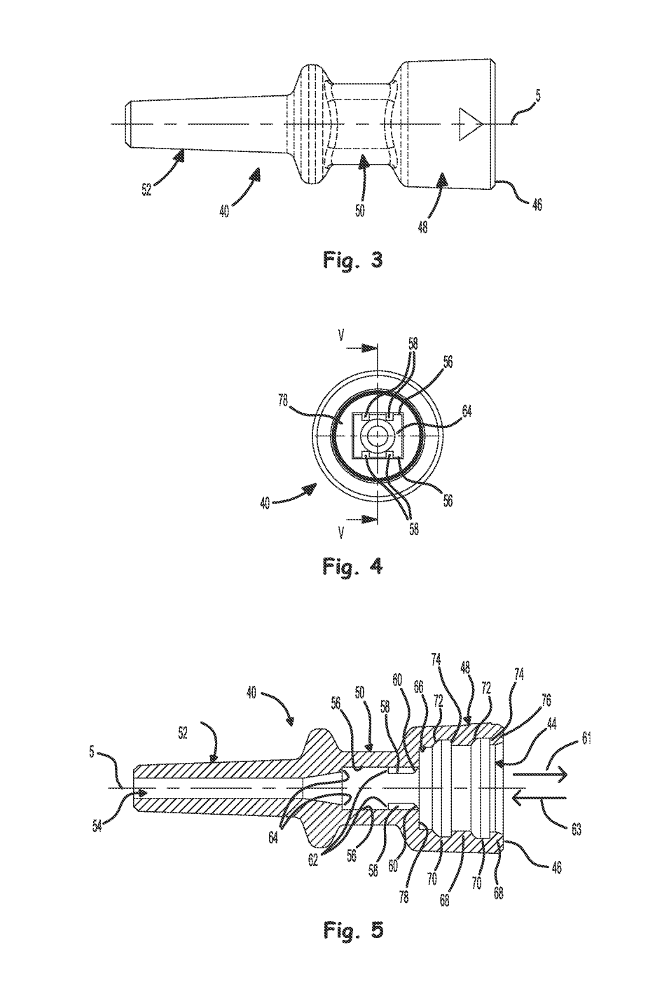

FIG. 2 shows how the assembly of an optical fibre connector 1 is completed when an outer connection sleeve 40, which is initially loosely fitted over the cable cladding 12, is slid forwards 42 until this engages with the inner housing 20. With reference now also to FIGS. 3 to 5, the engagement is such that approximately an endmost quarter the length of the inner housing 20 is left protruding from a cup-like opening 44 at a forwards end 46 of the outer connection sleeve 40.

The outer connection sleeve 40 has three portions, namely a connecting portion 48, a securing portion 50, and a strain relief portion 52, each of these portions sharing a common channel 54 that extends along the axis 5 of the connector 1. At least the connecting portion 48 of the connection sleeve is made of an elastic material. The connecting portion 48 has a substantially cylindrical outer surface 49. The inner profile of the channel 54 in the securing portion 50 has a generally rectangular shape that matches the external shape of the side walls 35, 37 of the inner housing 20, including on two opposite inner side wall surfaces 56 two pairs of parallel ridges 58, extending parallel with the connector axis 5. The size and position of the ridges 58 matches that of the slots 41 in the two opposite side walls 37 of the inner housing 20. The outer connection sleeve is integrally moulded in an elastomeric material, for example a natural or synthetic rubber material, preferably having a hardness of Shore D60.

The ridges 58 have a forwards ramp section 60, and so as the outer connection sleeve 40 is moved forwards 42 over the inner housing, the ridges deform and slide over the two opposite side walls 37 of the inner housing 20 and then expand resiliently again to locate into the slots 41 when the inner housing has been fully engaged inside that part of the channel 54 which is in the securing portion 50. The opposite rear ends 62 of each ridge 58 are square and transverse to the connector axis 5 to help retain engagement of the inner housing 20 with the outer connection sleeve 40 if this is later pulled in an opposite direction to the insertion direction 42. The movement of the inner housing 20 in the opposite direction is restrained by contact with a shoulder 64 that extends inwards into the channel 54 between the securing portion 50 and the strain relief portion 52.

The connecting portion 48 is substantially cylindrical in form, having a multiply grooved inner surface 66 with two parallel circular ribs 68 that extend concentrically around the connector axis 5. Each rib 68 has a corresponding groove 70 behind the rib 68 relative to a forwards connection direction 61, the connection direction being parallel with the connector axis 5. Each groove 70 is asymmetric, having a tapered or rounded edge 72 facing the forwards connection direction 61 and a sharp edge 74 facing a rearwards disconnection direction 63, which is opposite to the connection direction. The forwards end 46 of the outer connection sleeve 40 also has a tapered or chamfered edge 76 that is angled forwards and radially outwards. The inner surface 66 of the connecting portion 48 ends in an annular shoulder 78 that extends from the inner surface 66 radially inwards into that part of the channel 54 which is on the boundary between the connecting portion 50 and the securing portion 52.

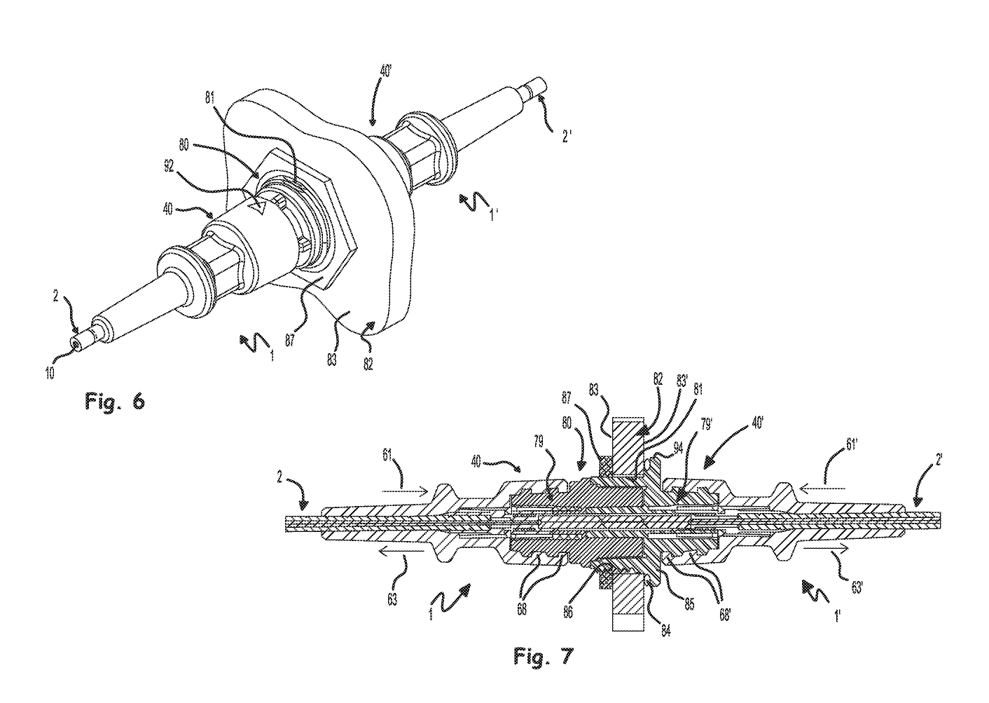

The cup-like opening 44 is wide enough to provide a clear gap between the grooved inner surface 66 of the connecting portion 48 and the outer surface 33 of the inner housing 20. As shown in FIGS. 6 to 12, this gap receives a connection plug 79 of a second optical fibre connector 80, which in this example is a unitor having two such plugs 79, 79′ for uniting two similar optical fibre connectors 1, 1′ according to the invention. In this description, numbers with and without a prime are used to indicate the same features of two identical connectors.

The grooved inner surface 66 of the connecting portion 48 and the opposed outer surface 33 of the inner housing 20 are therefore spaced apart from each other to form a socket that extends around the inner housing for receiving a corresponding plug portion 79, 79′ of a mating connector 80 along the connection direction 61.

The inner housing 20 is therefore held within the outer connection sleeve 40, the sleeve having the opening 44 at one end 46 for making an optical connection with the mating connector, which in this example is one plug portion 79, 79′ of the unitor 80.

The unitor 80 is mounted on a bulkhead 82 with the two plugs 79, 79′ on opposite sides 83, 83′ of the bulkhead. On one side 83′ of the bulkhead 82, the unitor 80 has an O-ring 84 compressed by a flange 85 to make a water-tight seal with the bulkhead, and on the other side 83 the unitor has an external thread 86 to which a threaded member 87 is tightened to compress the O-ring and make the seal. For reasons that will be explained below, one portion of the thread has a flat 81 where the depth of the thread is reduced.

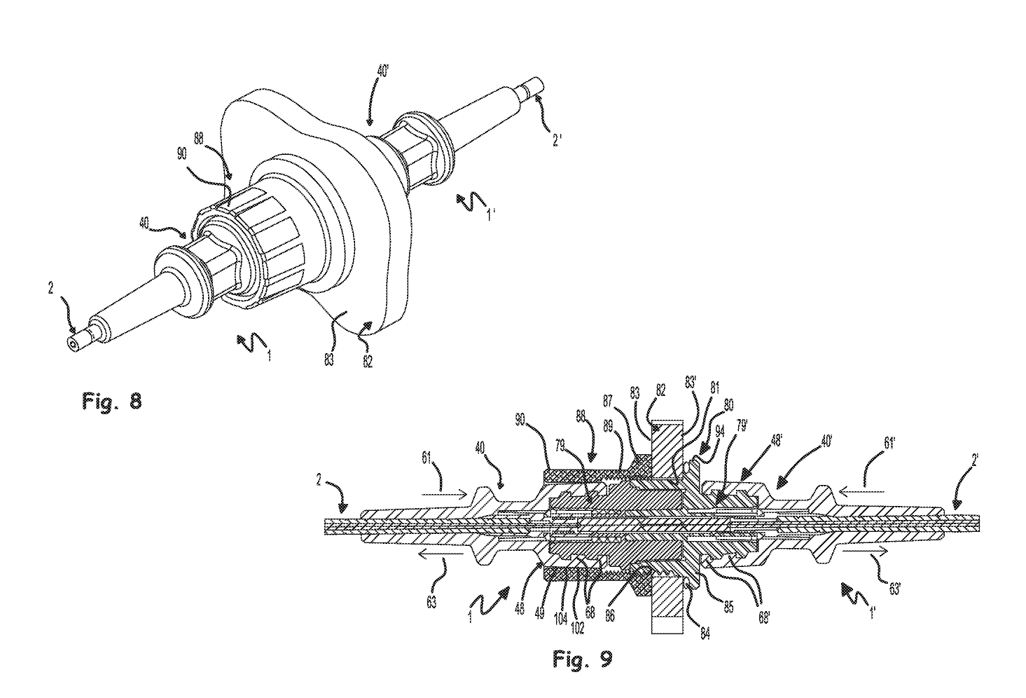

The threaded member is either a plain nut 87, as shown in FIGS. 6 and 7 or a retention sleeve 88 having an internally threaded portion 89, as shown in FIGS. 8 and 9. As will be explained in more detail below, the sleeve has a restraining portion 90 that acts as a restraining means for securing the connecting portion 48 of one of the two outer connection sleeves 40 when the two connectors 1, 80 are engaged with each other.

Each of the two connectors 1, 1′ is joined to the unitor 80 by aligning a visible or tactile indicator feature 92 on the outer connection sleeve 40, 40′ with an indicating feature on the unitor, for example the flat 81 in the external threads or a raised mark 94 on the flange 85, and then pushing the connecting portion 48 of the outer connection sleeve 40 over the unitor plug 79, 79′. As shown most clearly in FIG. 12, the plug has a generally cylindrical form with a multiply grooved external surface 95, 95′ that matches the multiply grooved internal surface 66 of the connecting portion 48. The plug 79, 79′ is substantially cylindrical in form, with the grooved outer surface 95, 95′ having two parallel circular ribs 96, 96′ that extend concentrically around the connector axis 5 and which match the profile of the connecting portion grooves 70, 70′. Each rib 96, 96′ has a corresponding groove 97, 97′ behind the rib 96, 96′ relative to the forwards connection direction 61, 61′. Each rib is asymmetric, having a tapered or rounded edge 98, 98′ facing the forwards connection direction and a sharp edge 99, 99′ facing the rearwards disconnection direction 63, 63′. The grooved outer surface 95, 95′ of the plug 79, 79′ ends in an annular shoulder 101, 101′ that extends radially outwards from the outer surface 95 of the plug, and which limits the movement of the outer connection sleeve 40, 40′ in the connection direction 61, 61′ when the sleeve end 46 comes into contact with this shoulder 101, 101′.

As the connecting portion 48, 48′ of the outer connection sleeve 40 is pushed over the unitor plug 79, 79′, the elastic material of the connecting portion is forced to stretch over the plug, which is of relatively inelastic material, until first one set of the matching ribs and grooves is engaged and then both sets of the matching ribs and grooves on the plug 79, 79′ and connecting portion 48, 48′. During connection, the tapered or rounded edges of matching ribs and grooves on the plug 79, 79′ and connecting portion 48, 48′ ride over one another as the material of the connecting portion stretches, thereby facilitating the connection of the connector 1, 1′ to the unitor 80.

When connected, the sharp edges of the connecting portion 48, 48′ and plug 79, 79′ engage with each other, and as these surfaces are substantially perpendicular to the connection axis 5, these help to restrain the connector 1, 1′ from being pulled out of connection with the unitor 80. However, because the connector portion 48, 48′ is elastic, a sufficient pulling force will allow the connector 1, 1′ to be disconnected from the unitor 80 without damaging the material of the outer connection sleeve 40, 40′.

Optionally, the outer dimensions of the plug surface 95, 95′ may be radially greater than the corresponding dimensions of the inner surface 66 of the connecting portion 48, 48′ when not stretched so that the material of the connecting portion is stretched by the plug when connected. This helps to ensure a positive contact.

The retention sleeve 88 is secured to the externally threaded portion 86 of the unitor after connection of the connector 1 to the unitor 80. The restraining portion 90 of the retention sleeve 88 has a cylindrical inner surface 102 that is separated by a clearance gap 104 from the substantially cylindrical outer surface 49 of the connecting portion 48. Therefore, once the retention sleeve 88 is connected to the externally threaded portion 86 of the unitor 80, the elastic material of the connecting portion 48 is no longer free to stretch outwards if the connector 1 is pulled away from the unitor 80, and so the retention sleeve 88 thereby acts as a restraining means for securing the connecting portion 48 of the outer connection sleeve 40 when the two connectors 1, 80 are engaged with each other. The ribs are thereby restrained from stretching over and disengaging with the corresponding ribs of the connection plug when the two connectors are pulled apart.

The retention sleeve 88 therefore helps to prevent accidental disconnection of the connectors 1, 80 or tampering that could degrade the optical connection. This is a particular benefit where the connection is made in a domestic environment, where an inexperienced end-user may have access to the optical fibre connectors.

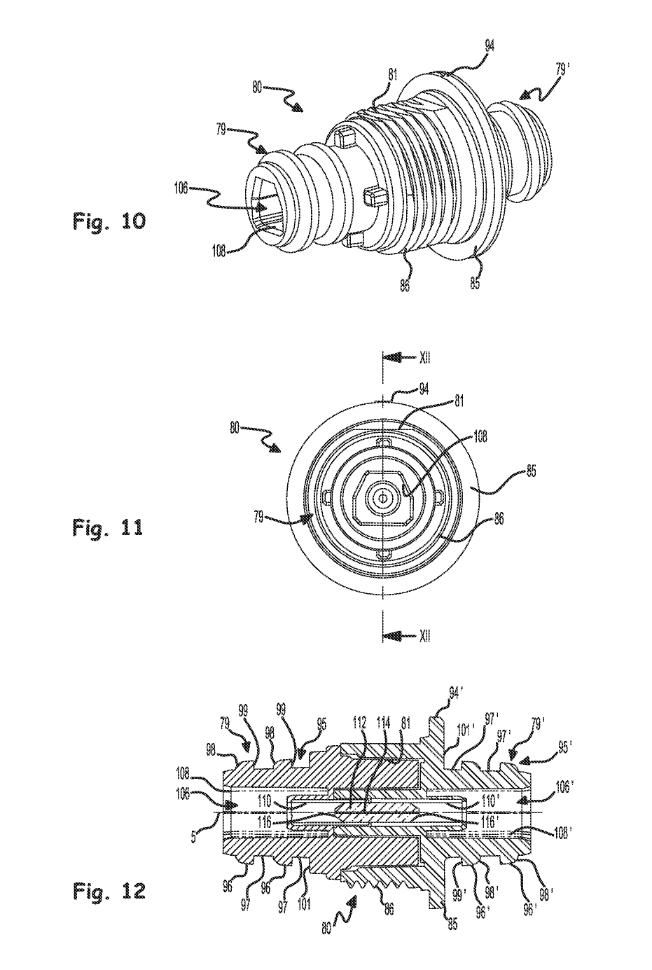

The internal construction of the unitor 80 and the making of the optical connections between the two connectors 1, 1′ and the unitor will now be briefly described with reference to FIGS. 10, 11 and 12, for the invention described above may be employed with different types of mating connector adapted to receive and align a fibre ferrule.

The unitor 80 has a pair of oppositely directed sockets 106, 106′ each of which has an internal wall 108, 108′ having a shape that matches that of the external wall 33 of the inner housing 20. Each socket leads to one of two split sleeves 110, 110′ which projects from opposite ends of a common cylindrical ferrule 112 held fixedly within the unitor. An optical fibre 114 is held within the unitor ferrule 112 and terminated at ferrule end faces 116, 116′. When the inner housing 20 of the connector 1, 1′ is plugged into the unitor socket 106, 106′, the projecting connector ferrule 14 is received within the split sleeve 110, 110′ and guided into abutting contact with the end face 116, 116′ of the unitor ferrule 112 to make the optical connection between the connector optical fibre 8 and the unitor optical fibre 114, as shown most clearly in FIGS. 9 and 12. When the abutting contact is made the spring 17 is compressed as the connector ferrule 14 is moved backwards, thereby ensuring positive contact between the connector and unitor optical fibres 8, 114. The secure engagement between the connecting portion 48 of the outer connection sleeve 40 and the plug 79, 79′ provides a restoring force for the force provided by the spring 17.

During assembly of the outer connection sleeve 40 to the fibre connector sub-assembly 21, the strain relief portion 52 is securely joined to the outer sheath 12 of the optical fibre cable 2, for example by means of an adhesive, a mechanical crimp, or other such means (not shown). After the optical connection has been made, the connecting portion 48, 48′ is securely joined to the connector plug 79, 79′. The elastic material of the connecting portion closely conforms with a relatively rigid plug. The close fit of the opposed ribs and grooves between the connecting portion 48, 48′ and connector plug 79, 79′ therefore helps to prevent water ingress through the interface between these components. The arrangement is therefore such that the connection between the connector 1, 1′ and the unitor 80 is water resistant, and also resistant to the ingress of dirt or other forms of external environmental contamination. Water or contamination therefore does not reach the region where the optical connection is made between the fibres 8, 114. In this example, the bulkhead 82 can also provide a barrier so that the optical fibre connection system can provide a full barrier between wet and dry environments, or dirty and clean environments.

It should be noted that although the inner housing 20 bears a resemblance to an inner housing used in a standard SC connector, the features of the inner housing in this optical fibre connector are preferably made larger in a radial direction so as not to be plug-compatible with a standard SC-style connector. The inner housing 20 also has no latch mechanism for engaging with a mating connector. It is then not possible to mistakenly connect a standard SC connector with any of the connectors of the invention described above.

Furthermore, although the invention has been described in terms of an optical fibre connector having a projecting ferrule, the invention is applicable to other types of connector, for example, a connector having a split sleeve for receiving a projecting ferrule of a mating connector.

Also, although the invention has been described above in relation to a through-bulkhead optical fibre connector system described above, the invention is equally applicable to an inline connector, or any other type of optical fibre connection arrangement between two optical fibre connectors.

The invention therefore provides a convenient push-fit and pull-release water resistant optical fibre connector and optical fibre connector system for making an optical fibre connection.

It is to be recognized that various alterations, modifications, and/or additions may be introduced into the constructions and arrangements of parts described above without departing from the spirit or scope of the present invention, as defined by the appended claims.

1. An optical fibre connector having a fibre connector sub-assembly and assembled about said sub-assembly an outer connection sleeve, said sub-assembly comprising an optical fibre and an inner housing, wherein:
the optical fibre is held within the inner housing along an optical axis, the optical fibre being terminated for optical connection to a mating connector along a connection direction;
the outer connection sleeve has a securing portion and a connecting portion, the securing portion being fixed to said sub-assembly so that the outer connection sleeve extends around said sub-assembly;
the connecting portion of said sleeve has an inner surface, the inner surface providing a socket for receiving a corresponding portion of said mating connector along said connection direction;
wherein said inner surface has at least one rib, said rib extending transverse to said connection direction, the connecting portion of said sleeve being elastic such that said at least one rib may, in use, stretch over and engage with a corresponding feature of said mating connector.

2. An optical fibre connector as claimed in claim 1, in which the fibre connector sub-assembly comprises spring biasing means and the ferrule is relatively moveable with respect to the inner housing along the ferrule axis and is spring biased along the ferrule axis towards said end face by the spring biasing means.

3. An optical fibre connector as claimed in claim 1, in which the fibre connector sub-assembly comprises a cylindrical ferrule, the optical fibre being held within the ferrule along an axis of the ferrule, the optical fibre being terminated at an end face of the ferrule for optical connection to said mating connector along said connection direction.

4. An optical fibre connector as claimed in claim 3, in which the fibre connector sub-assembly comprises spring biasing means and the ferrule is relatively moveable with respect to the inner housing along the ferrule axis and is spring biased along the ferrule axis towards said end face by the spring biasing means.

5. An optical fibre connector as claimed in claim 1, in which the securing portion holds the inner housing within the connecting portion, with an inner surface of the connecting portion being spaced apart from an outer surface of the inner housing to form said socket.

6. An optical fibre connector as claimed in claim 5, in which said at least one rib is bounded by at least one corresponding groove in said inner surface of the connecting portion.

7. An optical fibre connector as claimed in claim 5, in which said at least one rib projects inwards from said inner surface of the connecting portion.

8. An optical fibre connector as claimed in claim 7, in which said at least one rib is bounded by at least one corresponding groove in said inner surface of the connecting portion.

9. An optical fibre connector as claimed in claim 1, in which the socket extends fully around the inner housing.

10. An optical fibre connector as claimed in claim 1, in which the, or each, rib has an engagement surface for engaging with a corresponding feature of said mating connector, the, or each, engagement surface extending transverse to the connection direction.

11. An optical fibre connector as claimed in claim 1, in which there is a series of ribs spaced apart along the connection direction.

12. An optical fibre connector as claimed in claim 11, in which the series of ribs has a generally square profile in cross-section along the connection direction, said profile being asymmetric to facilitate engagement in connection direction and to hinder disengagement in the opposite direction with said corresponding feature of said mating connector.

13. An optical fibre connector as claimed in claim 1, in which the connecting portion has substantially cylindrical inner and outer surfaces.

14. An optical fibre connector as claimed in claim 1, comprising an end portion of an optical fibre cable, the optical fibre extending from said end portion of the optical fibre cable, in which the outer connection sleeve has a strain relief portion that is secured to the end portion of said optical fibre cable.

15. An optical fibre connector as claimed in claim 1, in which said connecting portion is formed of an elastomeric material.

16. An optical fibre connector system, comprising a first optical fibre connector and a second optical fibre connector, the first optical fibre connector having a fibre connector sub-assembly and assembled about said sub-assembly an outer connection sleeve, said sub-assembly comprising a first optical fibre, and an inner housing and the second optical fibre connector having a connection plug, wherein:
the first optical fibre is held within the inner housing along an optical axis, the first optical fibre being terminated for optical connection with the second optical fibre connector along a connection direction;
the outer connection sleeve has a securing portion and a connecting portion, the securing portion being fixed to said sub-assembly so that the outer connection sleeve extends around said sub-assembly;
the connecting portion of said sleeve has an inner surface, the inner surface providing a socket for receiving the connection plug of the second connector along said connection direction;
wherein said inner surface has at least one rib and the connection plug has at least one corresponding feature shaped to engage with said at least one rib, said rib extending transverse to said connection direction, the connecting portion of said sleeve being elastic such that said at least one rib may, in use, stretch over and engage with said at least one corresponding feature of the connection plug, said engagement serving in use to maintain said optical connection and provide a water resistant seal around the fibre connector sub-assembly.

17. An optical fibre connector system as claimed in claim 16, in which the fibre connector sub-assembly comprises a first cylindrical ferrule, the optical fibre being held within the ferrule along an axis of the ferrule, the optical fibre being terminated at an end face of the ferrule for optical connection to said mating connector along said connection direction.

18. An optical fibre connector system as claimed in claim 16, in which the second optical fibre connector comprises a second optical fibre, a second cylindrical ferrule, said first and second ferrules abutting each other when said optical connection is made between said first and second optical fibres.

19. An optical fibre connector system as claimed in claim 16, comprising additionally spring biasing means for providing positive contact with the first cylindrical ferrule to maintain said optical connection, the engagement of the outer connection sleeve with the corresponding feature of the second optical fibre connector serving in use to secure the fibre connector sub-assembly along the connection direction against a load from the spring biasing means resulting from engagement of said first ferrule made in the optical connection with the second optical fibre connector.

20. An optical fibre connector system as claimed in claim 16, in which the second optical fibre connector comprises restraining means for securing the outer connection sleeve when said first and second connectors are engaged with each other, said means, in use, restraining said at least one rib from stretching over and disengaging with said at least one corresponding feature of the connection plug when said first and second connectors are pulled apart.

21. An optical fibre connector system as claimed in claim 20, in which the restraining means is a substantially cylindrical sleeve affixed to the second optical fibre connector and extending around the connecting portion of the outer connection sleeve.
